(19) United States
(12) Patent Application Publication
(10) Pub. No.: US 2014/0026039 A1
(43) Pub. Date: Jan. 23, 2014

(54) FOUNDATIONAL TOOL FOR TEMPLATE CREATION

(71) Applicant: Jostens, Inc., Minneapolis, MN (US)

(72) Inventors: Gary Lundgren, St. Louis Park, MN (US); John Cutsinger, Oceoee, FL (US)

(21) Appl. No.: 13/946,744

(22) Filed: Jul. 19, 2013

Related U.S. Application Data
(60) Provisional application No. 61/673,512, filed on Jul. 19, 2012.

(51) Int. Cl. G06F 17/21

(52) U.S. Cl. CPC G06F 17/217
USPC 715/244

(57) ABSTRACT

A system for assisting in the creation of an electronic template for a page may include a computing device having a computer readable storage medium, a display device, and a processor in communication with each of the storage medium and display device, an interface module stored on the storage medium and configured for generating an user-interactive page designer on the display device, the page designer configured for designing the page, and a foundation module stored on the storage medium and configured to interact with the interface module to provide an interactive foundation tool in the page designer, wherein the foundation tool defines a plurality of regions on the page and each region is controlled by a plurality of rules executable by the processor to control the automatic spatial arrangement of a page element placed therein.

### CROSS-REFERENCE TO RELATED APPLICATIONS

The present application claims priority to U.S. Provisional Patent Application 61/673,512 entitled Modular Templates, filed on Jul. 19, 2012, the content of which is hereby incorporated by reference herein in its entirety.

### FIELD OF THE DISCLOSURE

The present disclosure relates generally to systems and methods for electronically developing pages in a book. More particularly, the present disclosure relates to systems and methods for efficiently and electronically laying out pages in a photo book. Still more particularly, the present disclosure relates to systems and methods for assisting a user in the creation of a photo book page template by providing a modularized foundation configured for receiving, sizing, and locating page elements such as image boxes, text boxes, embellishments, and other visual elements.

### SUMMARY

A system for assisting in the creation of an electronic template for a page may include a computing device having a computer readable storage medium, a display device, and a processor in communication with each of the storage medium and display device. The system may also include an interface module stored on the storage medium and configured for generating an user-interactive page designer on the display device. The page designer may be configured for designing the page. The system may also include a foundation module stored on the storage medium and configured to interact with the interface module to provide an interactive foundation tool in the page designer. The foundation tool may define a plurality of regions on the page and each region may be controlled by a plurality of rules executable by the processor to control the automatic spatial arrangement of a page element placed therein. The rules may also be configured to control the type of page element that the respective region is configured to receive.

As such, expeditious creation of a page template may be possible by relying on previously defined areas having preselected locations and sizes. After the template is created, the respective image boxes and/or text boxes that have been placed in the respective regions of the foundation and automatically sized and/or arranged, for example, may be populated with photos and text, respectively, to create the page.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a two page spread of a foundational tool according to some embodiments.

FIG. 2 is another view of the two page spread of the foundational tool of FIG. 1.

FIG. 3 is yet another view of the two page spread of the foundational tool of FIG. 1.

FIG. 4 is still another view of the two page spread of the foundational tool of FIG. 1.

FIG. 5 is a single page view of a foundational tool according to another embodiment.

FIG. 6 is a single page view of the foundational tool of FIG. 5 and including page elements.

FIG. 7 is a single page view of the foundational tool of FIG. 5 and including the page elements of FIG. 6 and further including assets populating the page elements.

### DETAILED DESCRIPTION

The present disclosure, in one embodiment, relates to a background or foundational tool for creating electronic templates with page elements that, in turn, may be populated with text, images, decorations, and other items when creating a book, photo book, yearbook, or brochure, for example. The background or foundational tool may include regions of a page that are adapted for placement of one or more page elements such as text boxes, image boxes, headings, and the like. The regions may have particularly defined locations and sizes on the page and may be adapted to adjust page elements placed in the regions to fit within the region alone or together with other page elements also placed in that region. As such, page elements may be automatically sized based on the regions they are placed in thereby expediting the template design process.

In past systems, for example, when an image box was placed on a blank page, the image box often required further manipulation to size the box relative to other elements on the page and properly adjust the position of the box on the page relative to other elements. (i.e., to line up edges, create equal spaces between elements, etc.) In some embodiments, the foundation tool described herein may provide a sort of “smart blank page” that allows for a template to be created much more quickly and efficiently because it may automatically assist in sizing and locating page elements when they are placed on the page. The alignment and spacing of the elements on the page may be predetermined and, thus, adjustment of the page element after placing it on the page may be reduced or eliminated.

The present disclosure may, thus, be valuable in the context of electronic layout for photobooks, memory books, yearbooks, brochures, magazines, and other situations where layout of items on a page may be performed. As such, the tools, systems, and features described herein may be included as part of a system adapted to facilitate creation of such books, brochures, etc. In one embodiment, the tools, systems, and features may be included with the yearbook creation system described in U.S. patent application Ser. No. 13/535,927 entitled System and Method for Yearbook Creation, filed on Jun. 28, 2012, the content of which is hereby incorporated by reference herein in its entirety. In another embodiment, the tools, systems, and features may be included with the photo book creation system described in U.S. patent application Ser. No. 12/011,195 entitled Method and System for Creating Customized Output, filed on Jan. 23, 2008, the content of which is also hereby incorporated by reference herein in its entirety.

It is to be appreciated that the present disclosure relates to a computing system and method for aiding in the layout-related activities described. As such, the system and tools described herein may include a computing system having a processor in communication with a computer-readable storage medium and a series of input and output devices, such as a mouse, touch screen, display, keyboard, voice controller, and the like. The system may include a plurality of modules or components stored on the computer-readable storage medium that are accessible by the processor for performing the mentioned activities. The mentioned activities may be monitored and/or controlled by a user that may view a user interface and interact with the system using the input and output devices. In addition, as particular designs, information, or data, are created by the modules or components, these designs or portions thereof may be stored on the computer-readable storage medium. Still further, it is appreciated that the system may be arranged on a network including a plurality of computing devices in communication over the network and the modules or components for performing activities may be stored on a central server, for example, or each of the computing devices performing the activities may store the modules or components. Still further, a portion of the modules or components may be stored on a central server and a portion may be stored on the computing devices performing the activities. Still other arrangements of the components and modules and the resulting data and/or information may be provided.

For purposes of context to the following discussion, it is to be appreciated that developing and/or laying out and designing a page of a memory book, photo book, magazine page, or other laid out media may involve one or more stages. For example, in some cases, a blank page may be obtained and one or more photos may be placed on the page and sized and arranged as desired. In addition, one or more text boxes may be placed on a page and populated with text relating to the photos or otherwise adding to the page. In other cases, however, a template may be created first. The template may be created for purposes of making the page design more efficient. That is, once the template is created, page assets such as photos and text may be placed in photo boxes and text boxes respectively that have been previously laid out as part of the template creation. This may facilitate faster page creation because the size and position of the respective photos and text may already have been determined and time spent adjusting these sizes and positions may be avoided. The present disclosure, in some embodiments, relates to the creation of the template and thus may allow for the creation of a template to be more efficient by aiding in sizing and positioning of page elements that may later be populated with assets such as photos, text, embellishments, etc.

As will be appreciated in this description, a page asset may include a photo, a line of text, a particular artistic accent or other media viewable by a person reviewing a finished product such as a yearbook, memory book, magazine, and the like. In contrast, a page element may be a tool or feature that holds and/or controls the appearance of a page asset. For example, a page element may include a photo box or image box that is adapted to hold a photo and control the appearance of the photo with respect to, for example, its size, color, hue, location, position, etc. In another example, a page element may include a text box that is adapted to hold text and control the appearance of the text with respect to, for example, its size, font, color, location, position, etc. Still other types of page assets and page elements may be provided and are not limited to the examples listed, but are intended merely to aid in the understanding of the following description. For example, in some embodiments, another type of page element may include a group of photo boxes and/or text boxes and the spatial and size relationships between the several items may be pre-defined or pre-configured. Still other types of page elements may be provided.

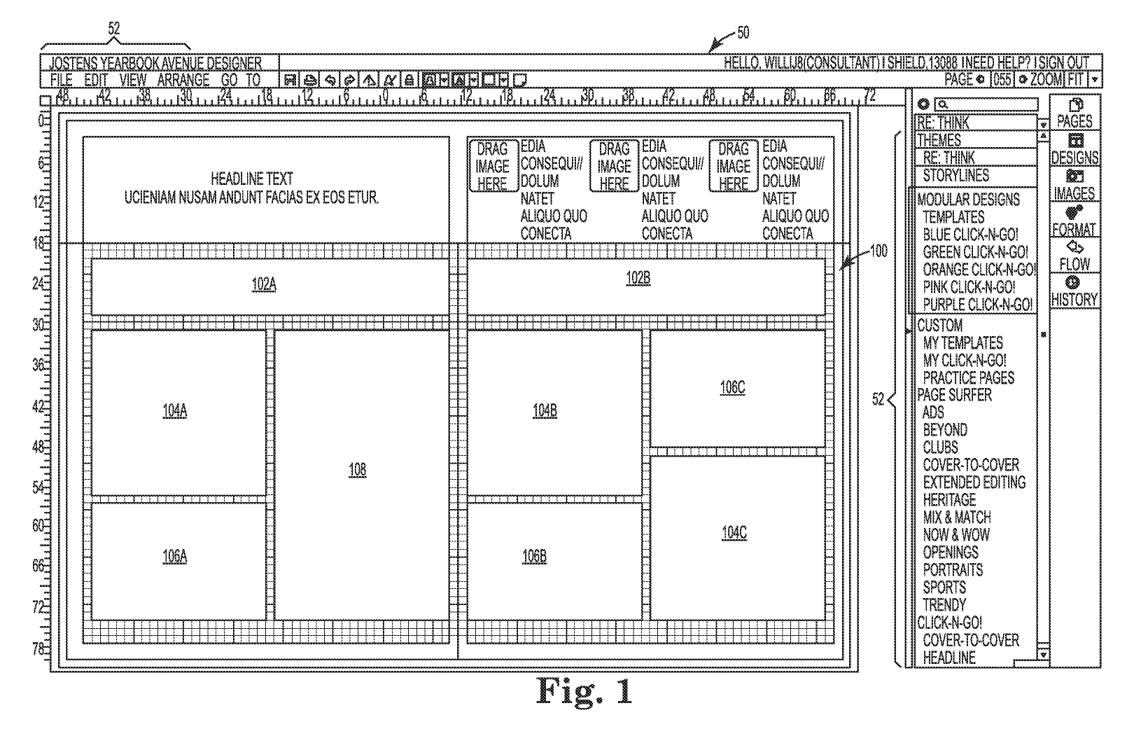

Referring now to FIG. 1, a page designer interface 50 is shown depicting a two page spread of a modular template or foundational tool 100 as part of the page designer interface 50. The page designer interface 50 may be configured for designing the page and may include a plurality of menus 52 and features available for designing the page including page themes, storylines, and the like. With respect to the foundational tool 100, each page of the two page spread may include one or more regions or zones that are particularly adapted to receive a selected type or types of page elements. The zones may have a particular location on the page and may be adapted to force page elements placed in the zones to fit within the zone. In the embodiment shown, the foundational tool 100, or modular template, includes zones 102, 104, 106, and 108. For example, zones 102 may be header zones or regions. Zones 104 may be in the body of the page and zones 106 and 108 may also be in the body of the page.

With respect to being adapted to receive particular types or groups of types of page elements, for example, a zone may be adapted to receive image boxes only, or it may be adapted to receive text boxes only, or it may be adapted to receive a particular group of image boxes. In still other embodiments, a zone may be adapted to receive some image boxes and some text boxes, but not other image boxes or other text boxes. The selected image or text boxes that a zone is adapted to receive may be based on size, shape, color, or other properties of the text or image boxes. In other embodiments, while a zone is adapted to receive a particular type or set of types of page elements, the zone may also receive elements not within the particular type or set of types. That is, the system may allow itself to be forced to put page elements in a zone that is not particularly adapted to receive that type of page element.

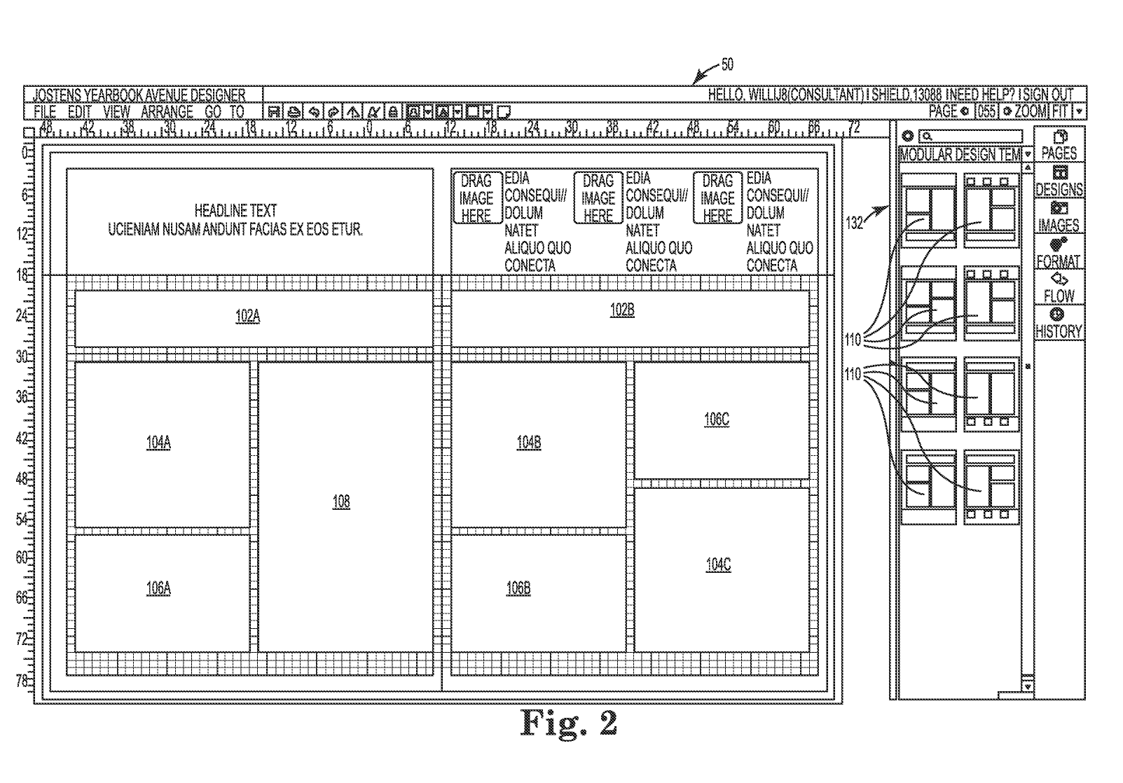

The menu 52 shown at the right of FIG. 1 on the interface 50 may allow for accessing alternative layouts 110 of the zones. For example, selecting the modular designs option may bring up a tool bar 132 similar to that shown in FIG. 2. That is, several alternative layouts 110 may be presented and a user may select from the alternative layouts 110. In some embodiments, a particular layout 110 may be modified and saved such that the user may create their own layouts 110 and make them available for later use. Once modified and saved, the saved layouts 110 may be available in the tool bar 132 of alternative layouts 110 on the user-interface 50. Accordingly, a user may cause the template creation process to be more seamless and efficient by creating layouts 110 configured to produce templates that they desire.

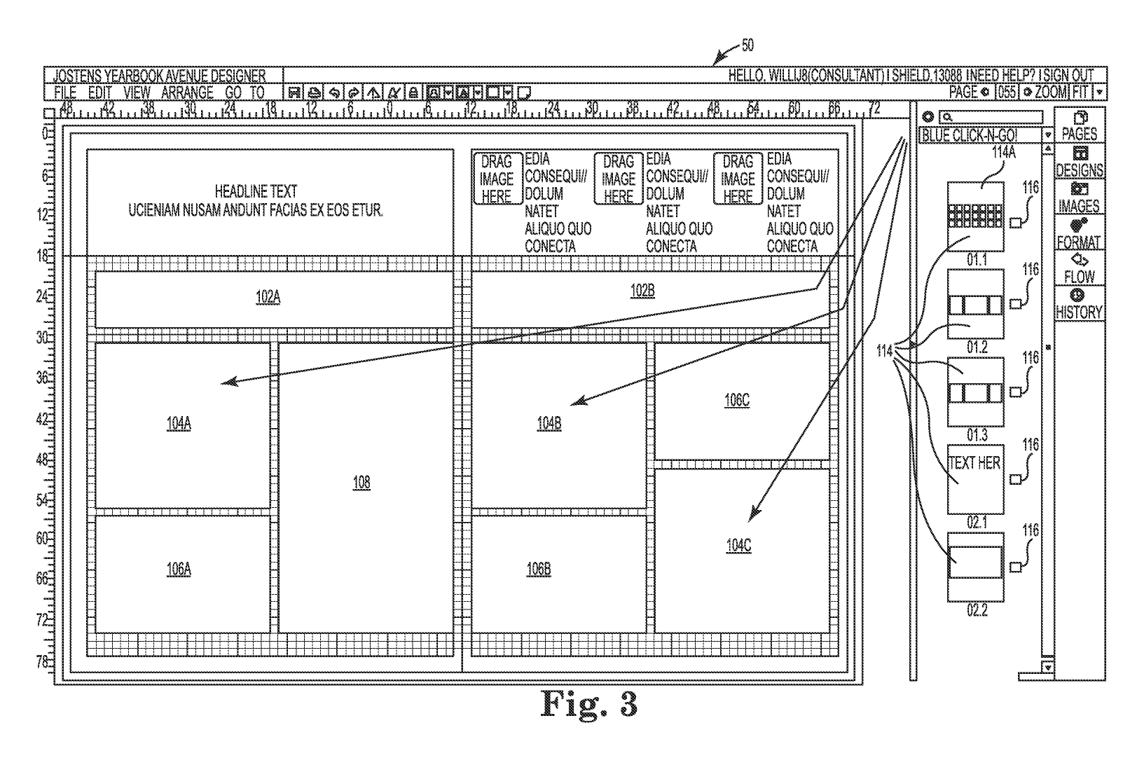

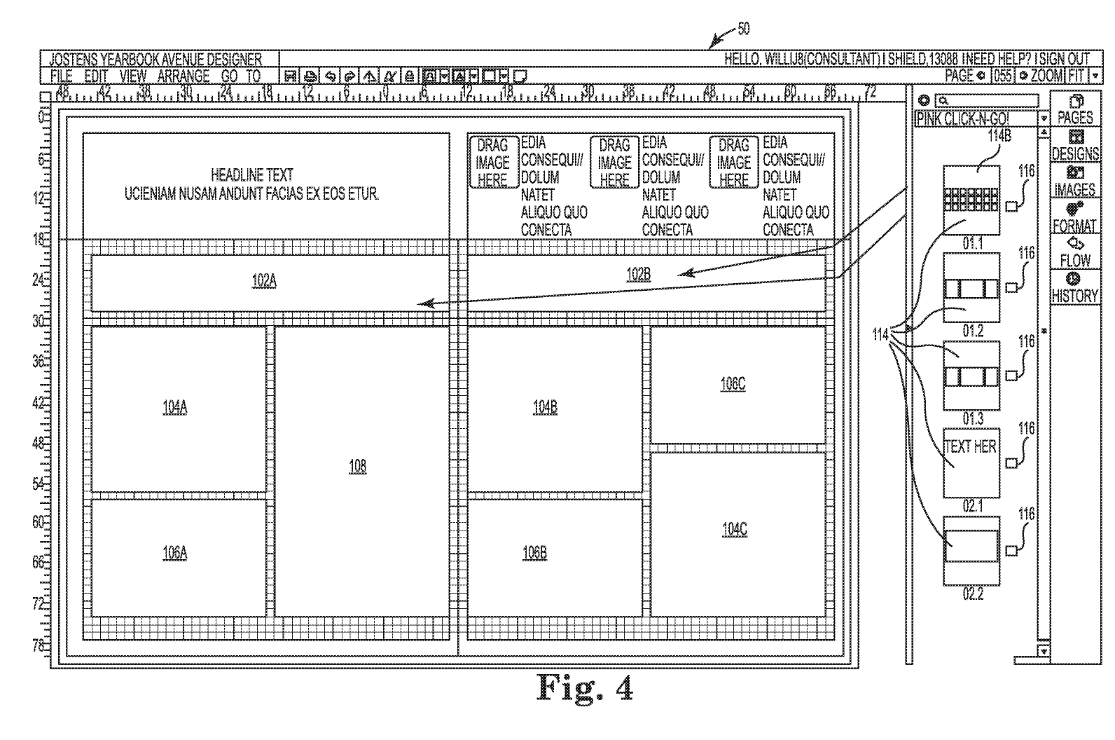

FIG. 3 shows another view of the two page spread of the foundation tool 100 of FIG. 1. In this Figure, the same foundation tool 100 is shown with the same layout 110 as in FIG. 1. However, in this view, the tool bar 132 at the right has been replaced with a series of page elements 114. Each of the page elements 114 (sometimes referred to as Click-n-Gos when including a pre-configured array of text boxes and/or image boxes) may include a reduced size view of the page element 114 and may be identified with a marker 116. The marker 116 may correspond to the zone that the page element 114 is adapted to be placed in. For example, in some embodiments, the zones on the page may be color coded each have differing colors. That is, for example, all zones 104 may be blue and all zones 106 may be pink, while all zones 108 may be green. Other colors may be used. In some embodiments, the markers 116 may be colored to correspond to the color of the zone that the adjacent page element 114 is adapted for placement in. In some embodiments, when the page element 114 is selected in the tool bar, and in addition or in alternative to the markers 116, the zones or regions that are adapted to receive the page element 114 may be highlighted, circled, bordered, or otherwise identified as zones that are adapted for receiving the selected page element 114. For example, when page element 114A is selected, all zones 104A, 104B, and 104C may be highlighted as zones that are adapted for receiving page element 114A. Similarly, as shown in FIG. 4, when page element 114B is selected, zones 102A and 102B may be highlighted or otherwise identified as being adapted to receive page element 114B. It is to be appreciated that when comparing FIG. 3 and FIG. 4, the menu at the right has been changed by the drop down at the top of the menu. For example, in FIG. 3, the “Blue Click-N-Go” menu was selected and on FIG. 4, the “Pink Click-N-Go” menu was selected. As such, while the first page element 114 in each menu has been selected, it may not be the same page element 114 and may be suitable for placement in different regions on the page. It is also to be appreciated that the several page elements 114 shown in the menu of FIGS. 3 and 4 include groups of image boxes and/or text boxes that have preconfigured relationships (i.e. Click-N-Gos). For example, each of page elements 114A and 114B of FIGS. 3 and 4 each include an array of image boxes that may be placed in a region and automatically sized to fit within the region. The image boxes of the page element may be later populated with photo assets. The result may include a plurality of relatively small pre-arranged images forming a sort of horizontal ribbon across the region in which the page element 114 is placed.

Once the page element 114 is selected, it may be dragged and dropped into a zone. In other embodiments, the page element 114 may be selected followed by selection of a zone in which to place the page element 114. That is, other methods of placing a page element 114 in a zone may be provided other than dragging and dropping.

When a zone on the modular template 100 receives a page element 114, the zone may automatically adjust the page element 114 to fit within the zone and as such, it may automatically adjust the size and location of the page element 114. Where other page elements 114 are already present within the zone, the zone may modify the size of the already present page element 114 to accommodate the new page element 114. For example, if a zone includes an image box and a user places an additional image box in the zone, the zone may reduce the size of the already present image box such that both image boxes will fit within the zone. A series of rules may be followed by the system for these spatial arrangements of a page element 114 within a zone or region. In some embodiments, the rules may include maintaining a particular margin around the series of elements 114 relative to the size of the region. In other embodiments, the rules may include maintaining a space between elements 114 in the region. In other embodiments, the rules may include causing like elements 114 to be like sizes. In some embodiments, the rules may include maintaining an aspect ratio of a page element 114. In still other embodiments, manual adjustment of a page element 114 within a zone may be provided. In this embodiment, once a selected page element 114 is manually resized, its position and/or size may be locked and the remaining elements 114 within that zone may be automatically sized and positioned to fit within the zone and around the manually adjusted page element 114. Still other rules may be used in the automatic location and size of the page elements 114 within a zone.

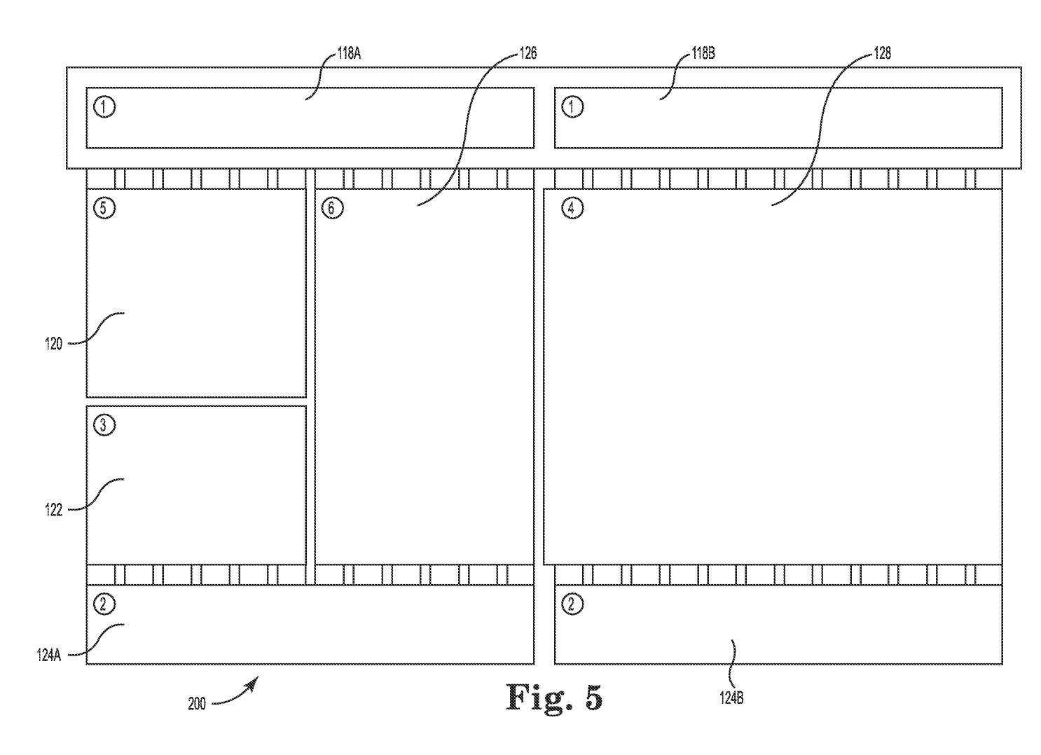

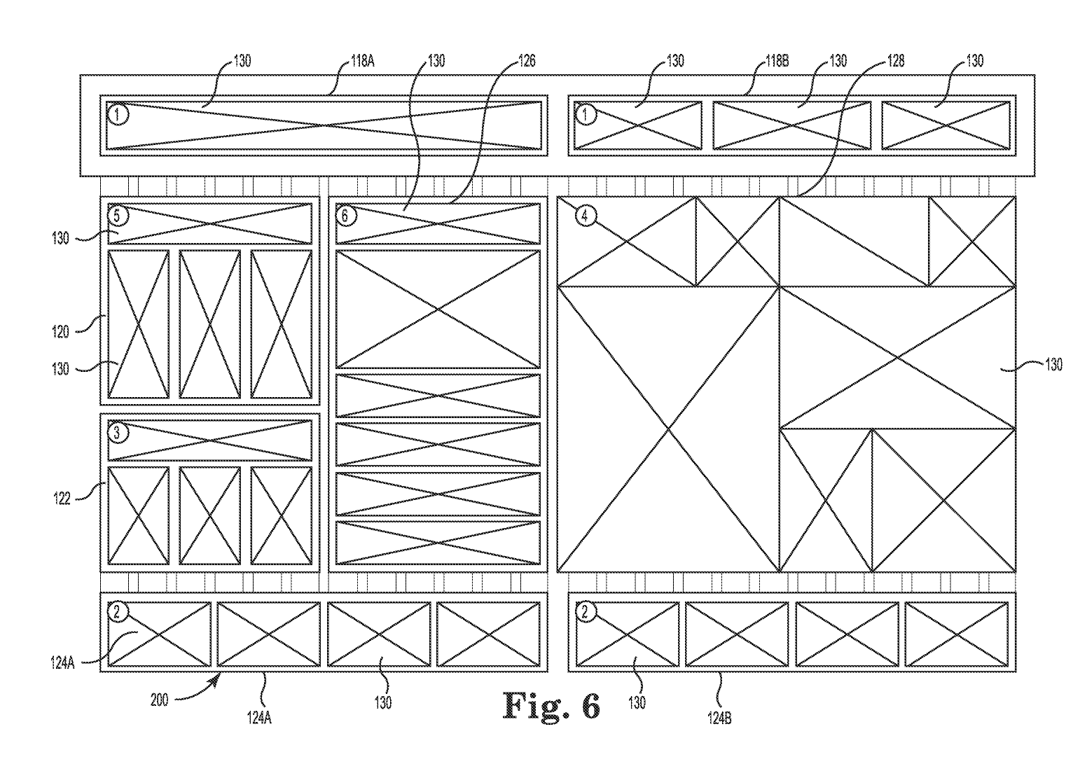

FIGS. 5-7 may help to show the functionality of the modular or foundational template tool 100. For example, FIG. 5 shows a single page view of a foundation tool 200 with a plurality of zones for receiving page elements 130. FIG. 6 shows the same modular tool 200 that is populated with page elements 130 (shown as empty boxes crossed with an X; not all are numbered) and, as such, defines a template ready for placement of assets such as text, photos, and the like. As can be seen in FIG. 6, some zones (e.g., 118, 120, 122, 124, and 126) include margins between the page elements 130 and the border of the zone and also include spaces between page elements 130. However, zone 128, for example, fully utilizes the space of the zone by providing no margin between the page elements 130 and the border of the zone 128 and also provides no space between the page elements 130 in the zone.

It is to be appreciated that zones may be populated with page elements in several ways. For example, zone 124A may have been populated by repeatedly dragging a series of single page elements in the form of three image boxes and a text box. The rules for zone 124A may have caused the several boxes to be equally spaced to fill the zone. Depending on the resulting location of the text box relative to the image boxes, the user may have dragged the text box to the left portion of the zone causing it to lock its location there and causing the image boxes to be equally spaced in the remaining area of the zone by the zone rules. In another example, zone 124A may have been populated by dragging a Click-N-Go that includes three image boxes and a text box where the image boxes and text boxes are preconfigured to be equally sized and spaced and where the text box is preconfigured to be located on the left. In yet another example, zone 128 may have been populated with a Click-N-Go that included seven image boxes and a text box that were all prearranged relative to one another and when dragged into zone 128, the Click-N-Go would have been sized to fill the space of the zone 128 and maintain the relationships of the several image boxes and the text box. This zone 128 may also have been populated by dragging in the several image boxes and text boxes separately, but given the varying sizes of the several image/text boxes, much manual adjustment may have been needed. Accordingly, it can be appreciated that the presence of the foundational tool 200 saves a large amount of time when populating a page with page elements.

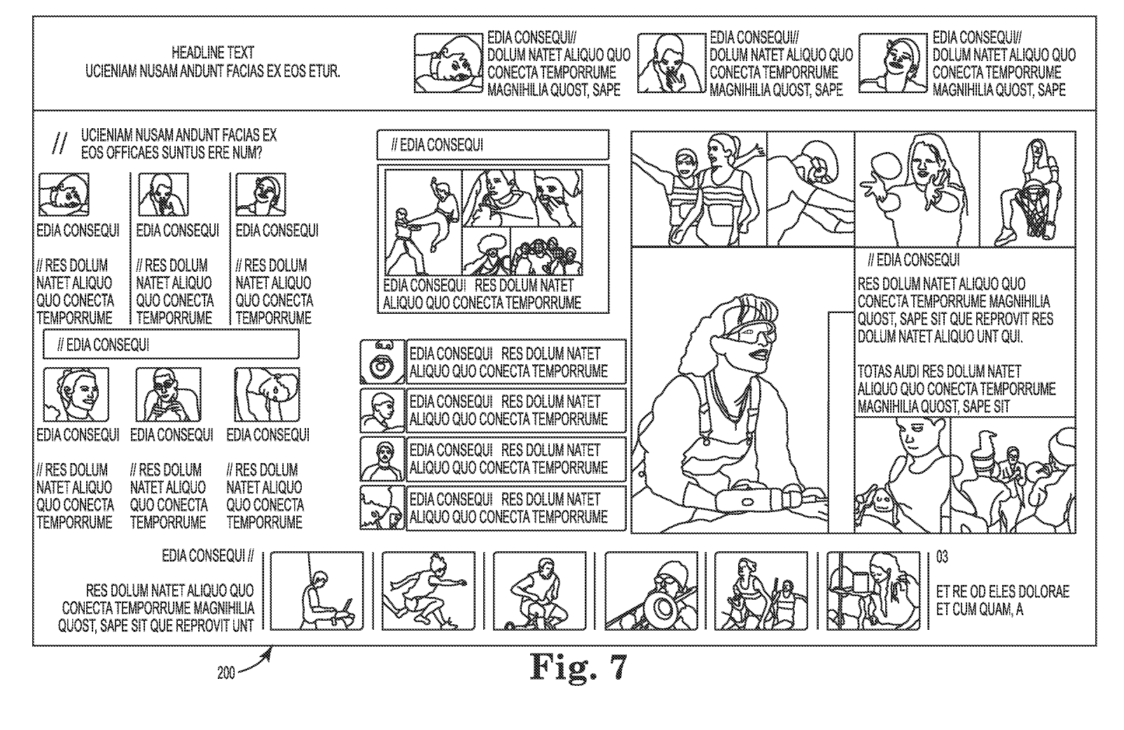

Turning now to FIG. 7, the page has been created by populating the page elements 130 with assets. That is, as can be seen in the figure, the page elements 130 have been populated with text assets and photo assets. The size and coloring of the photos may have been determined by the parameters (i.e., size, color, etc.) of the respective image boxes and the area for the text, the color, and the font, for example, may have been determined by the parameters (i.e., font, size, color, etc.) of the respective text boxes.

While the present disclosure has been described with reference to various embodiments, including preferred embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for assisting in the creation of an electronic template for a page, the system comprising:
a computing device having a computer readable storage medium, a display device, and a processor in communication with each of the storage medium and display device;
an interface module stored on the storage medium and configured for generating an user-interactive page designer on the display device, the page designer configured for designing the page; and
a foundation module stored on the storage medium and configured to interact with the interface module to provide an interactive foundation tool in the page designer, wherein:
the foundation tool defines a plurality of regions on the page; and
each region is controlled by a plurality of rules executable by the processor to control the automatic spatial arrangement of a page element placed therein.

2. The system of claim 1, wherein the display device is in communication with the processor over a network.

3. The system of claim 1, wherein automatic spatial arrangement of a page element includes positioning the page element within a selected region and sizing the page element based on parameters of the selected region.

4. The system of claim 3, wherein sizing the page element based on parameters of the selected region includes sizing the page element to substantially fill the selected region.

5. The system of claim 4, wherein sizing the page element to substantially fill the selected region includes maintaining the aspect ratio of the page element.

6. The system of claim 3, wherein automatic spatial arrangement of a page element includes coordinating the size of the page element with other page elements previously placed in the selected region.

7. The system of claim 1, wherein the plurality of rules executable by the processor are further configured to control the type of page element that the respective region is configured to receive.

8. The system of claim 7, further comprising a plurality of page elements stored on the computer readable storage medium, wherein the foundation tool is configured to provide a selection bar from which a particular page element may be selected.

9. The system of claim 8, wherein the foundation tool is further configured to identify the respective regions that are configured to receive the page elements.

10. The system of claim 9, wherein the foundation tool identifies the respective region by color-coding the page elements and the regions configured to receive the page elements.

11. The system of claim 10, wherein the color-coding the page elements includes providing a marker with a color adjacent to each page element in the selection bar.

12. The system of claim 9, wherein the foundation tool actively identifies the respective regions that are configured to receive the page elements by highlighting regions that are configured to receive a particular page element upon a user's selection of a page element.

13. The system of claim 9, wherein the plurality of page elements include text boxes and image boxes.

14. The system of claim 13, wherein the plurality of page elements include preconfigured groups of text boxes and/or image boxes.
